(19) United States
(12) Patent Application Publication
(10) Pub. No.: US 2008/0137341 A1
(43) Pub. Date: Jun. 12, 2008

(54) Method and Apparatus for Inducing Dazzle

(75) Inventors: Adam Alexander Hughes, Belfast (IE); Fergus O'Neill, Lurgan (IE); Kenneth Preston, Antrim (IE)

Correspondence Address: LOWE HAUPTMAN & BERNER, LLP, 1700 DIAGONAL ROAD, SUITE 300, ALEXANDRIA, VA, 22314, US

(73) Assignee: THALES HOLDINGS UK PLC, Surrey (GB)

(21) Appl. No.: 11/575,806

(22) PCT Filed: Sep. 16, 2005
(86) PCT No.: PCT/EP05/54633

§ 371 Date: Oct. 27, 2007

(30) Foreign Application Priority Data
Sep. 22, 2004 (GB) 0421088.6

(51) Int. Cl. F21V 19/02; G01S 7/48

(52) U.S. Cl. 362/285; 89/1.11

(57) ABSTRACT

There is disclosed a method and apparatus for successively and repeatedly illuminating a number of remote areas collectively defining a larger area with light in the form of a beam or beams to induce a physiological blink response or optical blink reflex in the illuminated eye of an animal (e.g., a human) within the area being illuminated. Each area being intermittently illuminated long enough to induce a blink response from an animal (e.g. human) subject there, after which another area(s) is illuminated in the meantime while illumination of the initial area is not required since the subject(s) there would still be recovering from their blink response.

The present invention relates to methods and apparatus for inducing a blink response in animals, and especially in humans. In particular, though not exclusively, the present invention relates to methods and apparatus for remotely suppressing potential aggressors or adversaries.

Long-range targeting of persons with non-lethal narrow beams of light has been used in the past in an attempt to subdue or suppress threatening or potentially aggressive/adversarial activity in the targeted subject. The method relies upon an assumed realisation by the target person that the narrow beam of light trained upon them emanates from a light source attached to a firearm which is also trained upon them. It has been found that such a realisation in a potential aggressor has a tendency to cause them to critically reconsider the wisdom of pursuing an aggressive course of action. Use of light beams has also been made in an attempt to dazzle an aggressor thereby to at least temporarily distract him/her to an extent sufficient to permit the user to take evasive action, or to prevent continuance of aggressive activity.

Unfortunately, this methodology requires that the location of the target aggressor is known, and that the aggressor is clearly visible. This may not be the case in many situations where the aggressor has taken steps to achieve concealment. Indeed, where the aggressor is not to be dissuaded from pursuing an aggressive course of action even in the knowledge of having been targeted, the method described above is doomed to failure.

The present invention aims to provide a non-lethal method and apparatus which may be used in suppressing a potential aggressor (e.g. an animal, especially a human), using light.

At its most general, the invention proposes successively and repeatedly illuminating a number of remote, and preferably fixed, areas (e.g. where an aggressor may be concealed) collectively defining a larger area (e.g. an area of terrain, a building) with light in the form of a beam or beams to induce a physiological blink response or optical blink reflex in the illuminated eye of an animal (e.g. a human) within the area being illuminated, each area being intermittently illuminated long enough to induce a blink response or reflex from an animal (e.g. human) subject there, another area(s) being illuminated in the meantime while illumination of the initial area is not required since the subject(s) there would still be recovering from their blink response. It is to be understood that a “blink response” refers to the involuntary physiological response or reflex of an animal (e.g. human) to close its eyelids in response to the eye being illuminated with bright light, the “response” including the time period during which the eyelids remain closed after having been involuntarily closed at the beginning of the blink response. The blink response is equivalent to the “flashblinding” of the subject to cause a temporary visual impairment which remains for a time period after the light source no longer illuminates the target eye (either because the eyelid(s) have closed and/or the light beam no longer illuminates the subject). This visual impairment interferes with the subject's ability to, among other things, aim a weapon accurately and/or engage in other aggressive activities.

In this way, the intermittently illuminated subject never recovers and is repeatedly dazzled by successive beams of light illuminating the area in which he/she/it is located. The subject's visual acuity is suppressed and so too is aggressive activity requiring such acuity (e.g. aiming and shooting a firearm). It is to be noted that the invention permits a large area to be illuminated by a light beam or beams of relatively small beam width at the target (e.g. beam “footprint”). One large/powerful beam is not required to be held continuously over the whole area concerned in order to illuminate it, as might otherwise be the case, but merely a relatively small and low power light beam(s) may be employed in a scanning manner to suppress aggressive activity in large areas. This greatly reduces cost (low power light sources) and also permits great increases in the full area over which a user is able to effectively induce a blink response to suppress aggressors.

According to a first of its aspects, the present invention may provide a blink inducer apparatus for remotely illuminating a human eye with light to induce the subject to blink in response thereto, the apparatus including:

illumination means for producing a beam of light which illuminates a given target area remote from the apparatus with sufficient light energy for inducing a blink response in an illuminated human eye within the illuminated target area;
control means for controlling the illumination means to illuminate a given target area for an illumination time period sufficient to induce the blink response, to thereafter illuminate a different target area instead of the given target area, and to subsequently re-illuminate the given target area after a recovery time period no greater than that sufficient for the subject to recover from the blink response. The recovery time period is preferably less than that sufficient for the subject to recover from blink response. Consequently, the recovery time period is preferably no greater than the time required for an aggressor to recover the aim of a weapon upon the user of the blink inducer apparatus, e.g. the aim having been made prior to illumination of the subject's eye, subsequently lost due to inducement of a blink response and only recovered (i.e. the subject “recovers” from the blink response) after the illumination is removed, the eye opened, visual acuity regained, and the aggressor's aim remade. That is to say, “recovery” from a blink response preferably includes the recovery of the state of the illuminated subject as it was immediately prior to the onset of the blink response. At the very least “recovery” from a blink response requires the re-opening of the subject's eyelid(s) after blinking, and preferably also regaining of visual acuity.

The control means is preferably arranged to control the illumination means to direct the beam of light to fall continuously on all of a given target area during the illumination time period. In this way the “footprint” of the beam of light is preferably held static on the target area to ensure that the whole of that area is illuminated for the duration of the illumination period. Alternatively, a beam casting a footprint having an area smaller than the target area may be employed and in such a case the control means is preferably arranged to direct the light beam to scan or “dither” upon the target area such that the footprint of the light beam rapidly moves periodically within the target area to periodically cover those parts of the target area not continuously covered by the footprint. This has the visual effect of causing the smaller footprint to “spread” into a larger footprint without increasing the width of the light beam.

Studies have shown that when the human eye responds physiologically (i.e. involuntarily or reflexively) to illumination with light energy by blinking, it most likely does so after having been illuminated for a time period of between about 100 ms and about 500 ms. Thus, the illumination time period preferably has a value from 50 ms to 750 ms, and more preferably from 100 ms to 500 ms. This aims to ensure that a physiological blink response or optical blink reflex is induced in the eye of the illuminated human subject.

Furthermore, it is estimated that the human subject attempting to recover visual acuity (e.g. recover a pre-illumination weapon aim) after having been induced to blink by illumination most likely requires between about 1 s and 10 s to fully recover. Thus, preferably the recovery time period has a value from 1 s to 15 s. More preferably, the recovery time period has a value from 1 s to 10 s. The precise time required by a subject to recover from a blink response depends upon the power of the illuminating light beam(s) used in the blink-inducing process.

As discussed above, the present invention permits the illumination of different target areas by the beam footprint during the time it takes a human subject in another target area to recover from their blink response. There is no need to continue to illuminate each target while the human subject has not recovered from their blink response. Thus, re-illumination of a given target area need only be done intermittently, with other target areas being similarly illuminated in the meantime. Most preferably, the control means is arranged to control the illumination means to separately illuminate and repeatedly re-illuminate each of a plurality of separate target areas which collectively define a greater target area. The greater target area may be as large as is required within the limits of the intensity of the beam of light being used, however it is contemplated that greater target areas of between tens of square metres to many thousands of square metres (e.g. an area equivalent to 200 m by 200 m) are to be illuminated in this way. The greater target area preferably has a value exceeding 1000 square metres, or exceeding 10000 square metres. The illuminated target areas have sizes preferably selected in dependence upon the generated output power of the illuminating light beam(s) employed, such that the illumination intensity (light power per unit area) of the beam at the target area remains sufficient to induce a blink response in an illuminated human eye within the beam.

The recovery time period (T) may be related to the illumination time period (t) by the relation: T/t=n−1 where n is the number of different target areas within the greater area being addressed by the beam of light.

Preferably the illumination means is arranged to produce a beam of light which illuminates the given remote target area with an intensity in the range 2 μW/cm² to 100 μW/cm² for the duration of the illumination period. This has been found to be sufficient to ensure a blink response in an illuminated subject.

The control means may control the illumination means to irradiate the given target area with the beam of light, thereafter to direct the beam of light to the different target means, and subsequently to re-direct the light beam to the given target means for re-illumination thereof. Alternatively, different beams of light may be used to illuminate different target areas, each beam emanating from the illumination means. The control means is preferably arranged to control the illumination means to direct the same beam of light from the given target area to the different target area thereby to scan the same beam of light from the illuminated given target area to the subsequently illuminated different target area.

The illumination means preferably includes laser means for producing said light beam as laser light. Other light sources may be used of course, however, due to their high degree of collimation, laser sources are preferred, especially for long-range applications where illuminated target areas are up to about 1 kilometre from the illumination means. The invention permits the use of low-power light beams and preferably power ratings of between 100 Watts and about 10 Watts are employed. Preferably, the light beam conveys radiant power of less than 100 Watts or less than 50 Watts, or less than 25 Watts.

A given target area illuminated by the beam(s) of light may be contiguous with, or partially overlapping with, one or more of the different target areas within the greater area, or may be completely separated from (i.e. no partial overlap, no contiguity) all different target areas. The successively illuminated different target areas may be successively illuminated in a random order, or by a systematic/regular order (e.g. a raster scanning methodology), or a mixture of both methods. The control means may be arranged to control the illumination means to vary the beam width of the beam of light as between illumination of different target areas (i.e. change the beam's “footprint” size). The beam of light may comprise a plurality of concurrent sub-beams of light which collectively define the beam of light used to illuminate a given target area. Thus, several sub-beams may be employed to produce the given beam “footprint” at the given target area. Sub-beams within the plurality of sub-beams may overlap with (e.g. some or all) other sub-beams at the footprint, they may be contiguous with other sub-beams at the footprint.

Preferably the control means is arranged to control and maintain the light intensity with which the beam of light illuminates, e.g. the light intensity of the beam of light at, the given remote target area according to changes in a measure of the distance between the illumination means and the remote target area such that the remote target area is illuminated with sufficient light energy for inducing said blink response. Preferably the control means is arranged to keep substantially constant the light intensity of the beam of light in cross-section at the given remote target area. It is preferable to use a range measuring device at or within the illumination means (e.g. a laser range finder) to measure the distance in question, the control means may then be arranged to control the light beam intensity according to the measured distance to keep the power density (i.e. intensity) of the light beam (in cross-section) constant, or at least within a predetermined range, at the target area whatever the measured range of the target area happens to be at a given time. Preferably, the control means includes range measuring means arranged to measure the distance between the illumination means and the given remote target area, and the control means is arranged to control and maintain the light intensity of the beam of light at the given remote target area according to changes in the measured distance such that the remote target area is illuminated with sufficient light energy for inducing said blink response. Alternatively, the measure of distance may be otherwise determined, or may simply be estimated by the user.

Preferably the control means also includes a beam control means for controlling the angle of divergence of the beam of light according to the aforementioned changes in the measure of the distance between the illumination means and the remote given target area thereby to control and maintain the light intensity of the beam in cross-section at the given remote target area. For example, the control means may control the illumination means and/or the beam control means to keep the cross-sectional area (or the footprint) of the beam of light at the target area substantially constant in size or area whatever the measure of distance happens to be. In this way a given light intensity at the remote target area (e.g. at the beam footprint) may be maintained without increasing the power output of the illumination means. Of course, the power output of the illumination means may also be controlled (e.g. increased or decreased) by the control means, depending upon the aforementioned measure of distance, to control the light intensity of the beam in cross-section at the target area and/or of the beam footprint. The intensity of the cross-sectional beam intensity, or beam footprint may, of course, be controlled by the control means by controlling not only the beam divergence angle but also the radiant power output of the illumination means concurrently to achieve the desired result.

The beam control means may include optical means arranged such that the beam of light generated by the illumination means passes through the optical means prior to exiting the blink inducer apparatus, the optical means being responsive to the control means to vary the angle of divergence of the exiting beam of light. The beam control means may comprise optical lenses and/or mirrors for controlling the angle of divergence of the exiting light beam. For example, the beam control means may comprise an optical lens or mirror placed within the optical path of the beam of light and moveable along that path in such a manner as to produce a “zoom” effect which causes the angle of divergence of the exiting light beam to increase/decrease as the optical lens/mirror is moved to and fro along the optical path of the beam within the apparatus. Of course, any other suitable optical zoom arrangement, such as would be readily apparent to the skilled person, may be employed to this end. The goal preferably is to control the cross-sectional area of the exiting light beam at the given remote target areas thereby to control and maintain the level of radiant intensity there.

In a further of its aspects, the present invention may provide a vehicle comprising a blink inducer apparatus according to the invention in its first aspect. The vehicle may be a land, air or sea vehicle. In an additional of its aspects, the present invention may provide apparatus for remotely suppressing visual acuity in a human subject including the blink inducer apparatus of the invention in its first aspect. In another of its aspects, the invention may provide apparatus for remotely suppressing a potential aggressor including the blink inducer apparatus of the invention in its first aspect.

It is to be understood that the apparatus described above may embody a method of remotely inducing a blink response in a human subject, of remotely suppressing visual acuity in a human subject and/or of remotely suppressing a potential aggressor.

Accordingly, in a second of its aspects, the present invention may provide a method for remotely illuminating a human eye with light to induce the eye of the subject to blink in response thereto, the method including: producing a beam of light for remotely illuminating a given target area with sufficient light energy for inducing a blink response in an illuminated human eye within the illuminated target area; illuminating a given target area for an illumination time period sufficient to induce said blink response, thereafter illuminating a different target area instead of the given target area, and subsequently to re-illuminating the given target area after a recovery time period no greater than (e.g. less then) that sufficient for the subject to recover from the blink response.

Preferably, the recovery time period is no greater than the time required for an aggressor to recover the aim of a weapon, that aim having been lost due to inducement of the blink response.

The method preferably includes directing the beam of light to fall continuously on all of a given target area during the illumination time period. The illumination time period preferably has a value from 50 ms to 750 ms, and more preferably from 100 ms to 500 ms. The recovery time period preferably has a value 1 s to 15 s, and more preferably from 1 s to 10 s.

Preferably, the method includes separately illuminating and repeatedly re-illuminating each of a plurality of separate target areas which collectively define a greater target area.

The greater target area preferably has a value exceeding 1000 square metres, or exceeding 10000 square metres.

The method may include irradiating the given target area with the beam of light from the illumination means, thereafter directing the beam of light to the different target means, and subsequently re-directing the light beam to the given target means for re-illumination thereof. Alternatively, different beams of light may be used to illuminate different target areas, each beam emanating from the illumination means. The method preferably includes redirecting the same beam of light from the given target area to the different target area thereby to scan the same beam of light from the illuminated given target area to the subsequently illuminated different target area.

The light beam is preferably a laser beam. The light beam preferably conveys radiant power of less than 100 Watts or less than 50 Watts, or less than 25 Watts.

A given target area illuminated by the beam(s) of light may be contiguous with, or partially overlapping with, one or more of the different target areas within the greater area, or may be completely separated from (i.e. no partial overlap, no contiguity) all different target areas. The successively illuminated different target areas may be successively illuminated in a random order, or by a systematic/regular order (e.g. a raster scanning methodology). The beam width or divergence angle of the beam of light may be varied as between illumination of different target areas (i.e. change the beam's “footprint” size and/or shape and proportions). For example, the footprint may be e.g. a wide-rectangular shape or a tall-rectangular shape, or any other suitable shape. Sub-beams within the plurality of sub-beams may overlap with (e.g. some or all) other sub-beams at the footprint, they may be contiguous with other sub-beams at the footprint. The recovery time period (T) may be related to the illumination time period (t) by the relation: T/t=n−1 where n is the number of different target areas within the greater area being addressed by the beam of light.

Preferably the method includes controlling and maintaining the light intensity with which the beam of light illuminates, e.g. the light intensity of the light beam at, the given remote target area according to changes in a measure of the distance between the beam source and the given remote target area such that the remote target area is illuminated with sufficient light energy for inducing said blink response. Preferably the beam is controlled to keep substantially constant (or at least within a predetermined range) the light intensity of the beam of light in cross-section at the given remote target area. It is preferable to use a range measuring device (e.g. a laser range finder) to measure the aforesaid distance and to control the light beam according to the measured distance to keep the power density (i.e. intensity) of the light beam (in cross-section) constant at the target area whatever the measured range of the target area happens to be. Preferably, the method includes measuring the distance between the beam source and the given remote target area, and controlling and maintaining the light intensity of the beam of light at the given remote target area according to changes in a measured distance such that the remote target area is illuminated with sufficient light energy for inducing said blink response.

Preferably the method includes controlling the angle of divergence of the beam of light according to the aforementioned measure of distance thereby to control the light intensity of the beam in cross-section at the given remote target area. For example, the method may include controlling the beam of light to keep the cross-sectional area (or the footprint) of the beam of light at the target area substantially constant in size or area whatever the measure of distance happens to be. The power of the light beam may also be controlled (e.g. increased or decreased) according to the method, depending upon the measure of distance, to control the light intensity of the beam at the target area and/or of the beam footprint. The intensity of the cross-sectional beam intensity, or beam footprint may, of course, be controlled by controlling not only the beam divergence angle but also the radiant power output of the illumination means concurrently to achieve the desired result.

The beam may be manually, automatically or remotely directed to a given greater target area for the purposes of scanning target areas within the greater area.

In another of its aspects, the present invention may provide a method of remotely suppressing visual acuity in a human subject including inducing the subject to blink according to the method of the present invention in its second aspect.

In yet a further of its aspects, the present invention may provide a method of remotely suppressing a potential aggressor including inducing the potential aggressor to blink according to the method of the invention in its second aspect.

Non-limiting examples of the invention are described below with reference to the accompanying drawings in which:

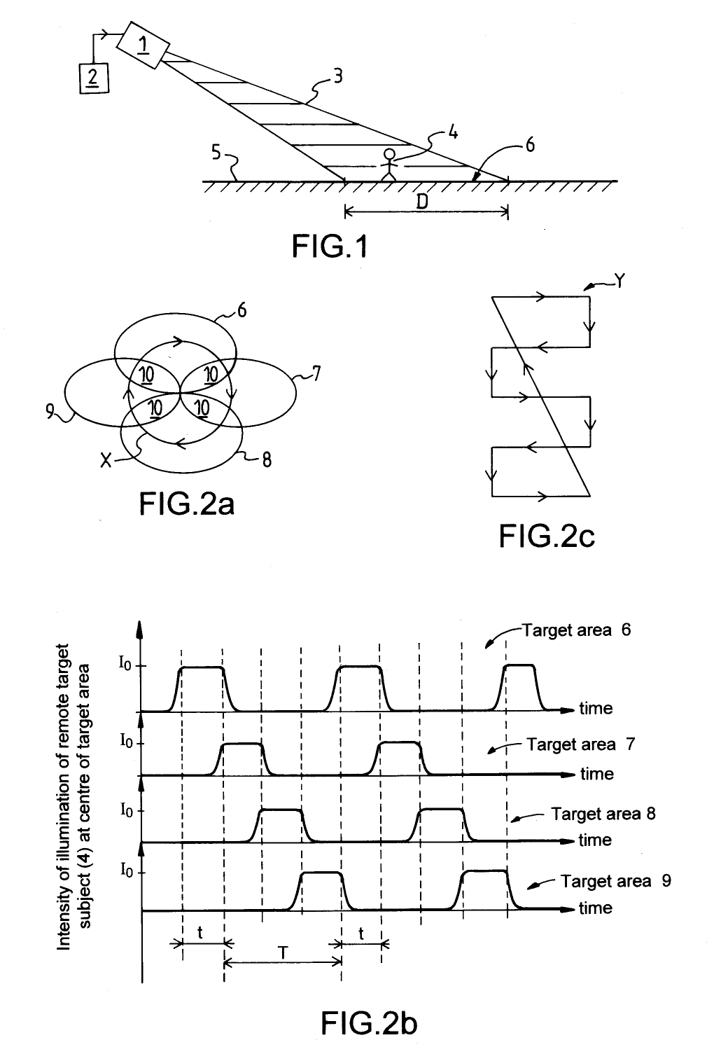

FIG. 1 schematically illustrates a blink inducer apparatus;

FIGS. 2a, 2b and 2c schematically illustrate a group of target areas, and the level of illumination directed to a given target area as a function of time and an example of a raster scan pattern;

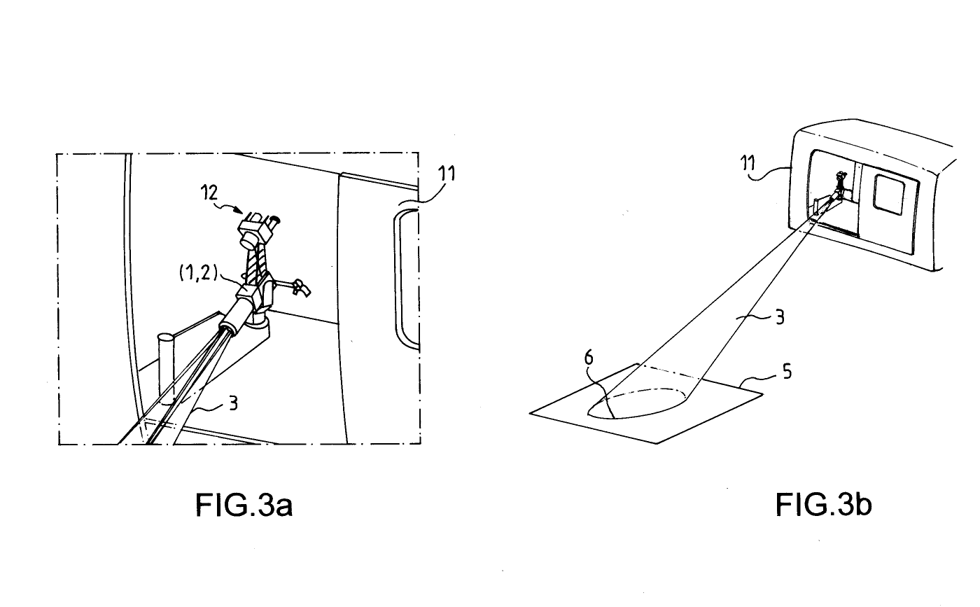

FIGS. 3a and 3b schematically illustrate a helicopter comprising apparatus for suppressing aggressive activity incorporating the blink inducer apparatus of FIG. 1;

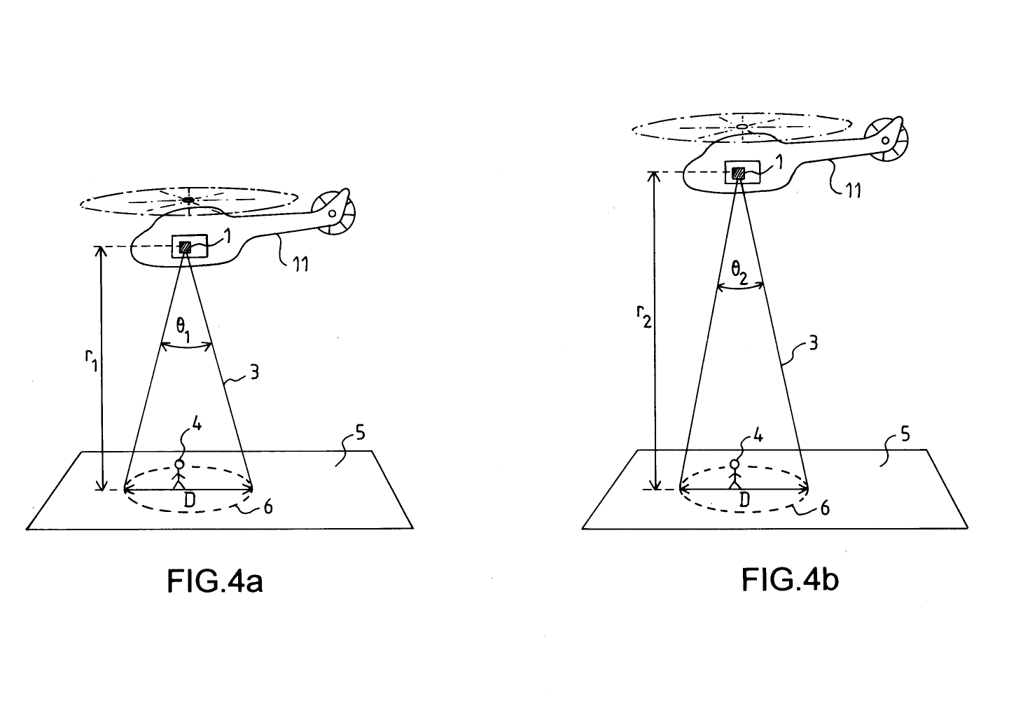

FIGS. 4a and 4b schematically illustrate beam divergence control for maintaining illumination intensity at a given target, and as between different target areas.

In the figures, like reference signs are assigned to like items.

FIG. 1 schematically illustrates a blink inducer apparatus (1,2) for producing a beam 3 of laser light (either a single beam or a composite of concurrent sub-beams) for remotely illuminating the eye of a remote human subject 4 with light to induce the eye of the subject to blink in response thereto.

The apparatus includes a laser light source for producing the beam(s) of light which illuminates a given target area 6 of terrain 5 remote from the apparatus with sufficient light energy for inducing a blink response in an illuminated human eye within the illuminated target area. The apparatus also includes a control unit 2 for controlling the laser source to illuminate the target area 6 for an illumination time period sufficient to induce the blink response in the subject 4. A suitable illumination time period is between 100 ms and 500 ms.

The control unit also controls the laser source 1 to subsequently illuminate a different target area (e.g. area 7, FIG. 2a) after having illuminated the first target area 6 for the duration of the illumination time period. This subsequent illumination is also maintained at the different target area, instead of at the initial target area 6, for another illumination time period having a value suitably between 100 ms and 500 ms in order to induce a blink response in the illuminated eye of any human subject within that different area. The control unit 2 controls the laser source 1 to subsequently illuminate further different target areas, each successively illuminated target area being different from the immediately preceding target area illuminated, and each being illuminated instead of the immediately preceding target area. In each case, the control unit 2 controls the laser source to illuminate the currently illuminated target area for an illumination time period sufficient to induce the blink response in the eye of any human subject there. A suitable illumination time period for any illuminated target area is between 100 ms and 500 ms.

In this way, the control unit 2 controls the laser source so as to scan the footprint “D” of the laser beam over a number of different target areas on the terrain 5 without ever simultaneously illuminating all parts of each such target area.

The control unit 2 is further arranged to control the laser source 1 to re-illuminate each previously illuminated target area (e.g. area 6) after a recovery time period no greater than that sufficient for the subject to recover from the blink response induced in him/her by the preceding illumination of that target area. Thus, the laser beam is controlled to return its footprint separately to each of the different target areas it has previously illuminated, and subsequently left, before or upon the lapsing of a predetermined time period (the recovery time period) measured from the end of the previous illumination of the target area in question. Consequently, any human subject within one of the plurality of different target areas who has been induced to blink by previous illumination will not have been able to recover fully before the laser beam re-illuminates him/her and induces a further blink response.

FIG. 2a schematically illustrates a group of contiguous or overlapping different target areas (6, 7, 8 and 9) which collectively define a greater target area scanned by the laser beam 3 of the laser source 1 in the intermittent manner described above under the control of the control unit 2. The control unit first directs the laser beam 3 to illuminate the first target area 6 for a suitable illumination time period, after the elapsing of which it control the laser source to illuminate a different, but partially overlapping second target area 7 for a subsequent suitable illumination time period (which need not be the same as that used for target area 6). After the time period for illumination of target area 7 has elapsed, the control means causes the laser source to illuminate a different but overlapping third target area 8 which overlaps the previous target area 7 but is only contiguous with the first target area 6 (it may overlap the first area if required), and holds the footprint of the laser beam there for a suitable illumination time period before being moved to a fourth different target area 9. The footprint of the laser beam is held upon the fourth target area, which partially overlaps the first and third target area but which is only contiguous with the second target area, for a suitable illumination time period only.

Subsequently, the control means directs the laser beam to re-illuminate the first target area 6. This cyclical illumination pattern may then be repeated as required to repeatedly induce blinking, and prevent recovery therefrom, within the whole greater area defined by the four target areas 6, 7, 8 and 9. The overlapping areas 10 as between successively illuminated target areas simply avoids in-illuminated gaps in the greater area. The scanning of the beam footprint effectively follows a circular scanning path “x” which repeats once every recovery time period. Other scanning paths may be employed, such as the raster-type scanning path “y” of FIG. 2c, or a mixture or combination of paths “x” and “y”. Furthermore, according to any aspect of the invention the above scanning procedure could be such as to move the beam footprint continuously across target areas rather than “stepping” from one target area to another. This would not require the footprint to be held at a given target area but merely to sweep across it at suitable speed. A random element to the raster-type scanning path may be used so that a remote subject does not learn the scanning process being used and therefore cannot learn when to close his eyes at the correct time to avoid being dazzled.

FIG. 2b illustrates graphically the illumination of, and the duration of the illumination time period for, each one of the four target areas of FIG. 2a, and the recovery time period between successive re-illuminations of each target area by the laser beam 3. In this example the same illumination time period (t) is employed for each target area, and each target area is re-illuminated immediately after the other three target areas of the greater area have each been illuminated for this period. Thus, the recovery time period (T) in this example, is related to the illumination time period (t) by the relation: T/t=n−1 where n is the number of different target areas within the greater area being addressed by the laser beam 3.

The laser beam 3 illuminates the first target area 6 with light of intensity I₀ for time period “t”, after which illumination is removed, only to return after time “T”. Immediately after time period “t” the second target area is illuminated by the beam at the same intensity for the same time period “t” after which illumination is removed, only to return after time “T”, and so on for the third and fourth target areas until a time 3t has elapsed at which point the beam returns to re-illuminate the first target area for another period “t”. FIG. 2b also illustrates the intensity of illumination as would, for example, be experienced by a remote subject 4 located at the centre of a respective one of the four target areas concerned.

FIGS. 3a and 3b illustrates a helicopter 11 (hovering, transiting or landing/take-off) incorporating apparatus 12 for suppressing potential aggressors. The apparatus 12 includes the blink inducer apparatus and methods described with reference to FIGS. 1, 2a and 2b. The laser beam 3 comprises multiple concurrent sub-beams. In alternative embodiments the apparatus may be located on any platform, structure or terrain.

FIGS. 4a and 4b schematically illustrate control of the angle of beam divergence (?) for the purposes of maintaining a given illumination intensity of the light beam in cross-section at a given target area.

Referring to FIG. 4a, consider the blink inducer apparatus 1 on board a hovering helicopter 11 at an altitude r₁ above an area of terrain 5 within which a human subject 6 is located. The illumination means of the blink inducer apparatus produces a beam of light 3 which diverges at an angle of beam divergence ?₁ as the beam extends away from the illumination means. The beam illuminates a given target area 6 within the terrain 5 encompassing the target subject 6. The diameter D of the footprint produced by the beam 3, which defines the given target area, is related to the distance r₁ between the illumination means and the remote target area 6 by the relation:

D=2r₁ tan(θ₁/2)

Thus, the cross-sectional area (A) of the beam 3 at distance r₁ from the illumination means is given by:

A=πr₁² tan²(θ₁/2)

Thus, for a radiant beam power P, the radiant intensity I₁ of the beam, in cross-section, at distance r₁ is:

$${I}_{1} = \frac{P}{π {r}_{1}^{2} {tan}^{2} ( {θ}_{1} / 2 )}$$

The control means includes range-finding means (e.g. laser range finder, not shown) which periodically measures the value of the distance r of each given target area immediately prior to, or during, the illumination thereof, and the control means responds to the measured distance value to control the angle of beam divergence ? such that the value of I is maintained at a predetermined value. This value is preferably a value between 2 μW/cm² to 100 μW/cm².

Should the distance between the target area 6 and the illumination means increase to a new value, e.g. r₂>r₁, then the range-finding means will detect this and the control means then responds to such detection by controlling an optical means in the form of a zoom lens (or the like, not shown) of the apparatus—through which the light beam passes before exiting the apparatus—to adjust the angle of beam divergence ?₁ such that it acquires a smaller value ?₂<?₁. FIG. 4b shows this.

The control means adjusts the beam divergence angle ? such that the cross-sectional area of the light beam at a distance r₂ from the illumination means is equal to the cross-sectional area of the light beam as it was at distance r₁ from the illumination means when its divergence angle was ?₁. This ensures that the intensity of illumination in cross-section at the given target area 6 is maintained, whether at distance r₁ or at distance r₂, without having to adjust the radiant power output of the beam in question. The cross-sectional diameter D of the beam 3, and its footprint 6, is maintained at both distances. Thus, the radiant intensity of the beam in cross-section at distance r₂ is given by:

$${I}_{2} = \frac{P}{π {r}_{2}^{2} {tan}^{2} ( {θ}_{2} / 2 )} = {I}_{1}$$

Accordingly, the control means is arranged to control the general angle of divergence (?), in response to a measured target area distance (r), according to the relation:

θ=2 arctan(β/r)

where

$$β = \sqrt{\frac{P}{π I}}$$

and where I, the beam intensity in cross-section at the target area, is a predetermined fixed value preferably between 2 μW/cm² and 100 μW/cm².

If the measured range value (r) is large and value β is small, then:

$$θ \approx \frac{2 β}{r}$$

and the control means may be arranged to adjust the beam divergence angle (?) in verse proportion to the measured distance (r) to the target area.

In other embodiments, the control means may adjust both the radiant power (P) and the beam divergence angle (?) of the light beam, according to the above relations, to maintain the cross-sectional beam intensity (I) at its predetermined value for varying target distances (r).

Though beam divergence angle has been discussed as being varied in response to a change in the measured distance to a given target area, it is to be understood that the control means, according to the invention in any of its aspects, may be arranged also to control the beam divergence angle (?), and/or radiant beam power P, in response to measured difference in the distance to a subsequent target area (subsequent in the beam's scanning) as compared to the distance to a different given target area illuminated immediately previously thereby. This difference may occur without any change in the position of the illuminating means of course.

The optical means, via which the control means controls the beam divergence angle (?) may be a zoom lens arrangement comprising a lens system moveable to and fro along the axis of the beam in such a way as to increase/decrease the divergence angle (?) of the beam as it exits the optical means. Mirrors (e.g. parabolic mirrors) may be used in addition to, or as an alternative to, the lens system in the same or similar way to produce the same effect.

Thus, a key advantage provided by the present invention in any of its aspects is that the same beam of light—such as a laser beam (whether comprised of a single beam or multiple concurrent sub-beams)—is used to sequentially illuminate different target areas repeatedly thus increasing the effectiveness of the beam by a factor T/t

It is to be understood that variations to the examples described herein, such as would be apparent to the skilled addressee, may be made without departing from the scope of the present invention.

1. A blink inducer apparatus for remotely illuminating a human eye with light to induce the eye of the subject to blink in response thereto, the apparatus including:
illumination means for producing a beam of light which illuminates a given target area remote from the apparatus with sufficient light energy for inducing a blink response in an illuminated human eye within the illuminated target area;
control means for controlling the illumination means to illuminate a given target area for an illumination time period sufficient to induce said blink response, to subsequently illuminate a different target area instead of the given target area, and to re-illuminate the given target area after a recovery time period no greater than that sufficient for the subject to recover from the blink response.

2. A blink inducer apparatus according to any preceding claim wherein the control means is arranged to control the illumination means to keep the cross-sectional area of the beam of light at the target area substantially constant.

3. A blink inducer apparatus according to any preceding claim wherein the control means is arranged to maintain the light intensity with which the beam of light illuminates the given remote target area according to changes in a measure of the distance between the illumination means and the given remote target area such that the remote target area is illuminated with sufficient light energy for inducing said blink response.

4. A blink inducer apparatus according to any preceding claim wherein the control means is arranged to control the illumination means to keep substantially constant the light intensity of the beam of light in cross-section at the given remote target area in response to changes in a measure of the distance between the illumination means and the given remote target area.

5. A blink inducer apparatus according to any preceding claim wherein the control means also includes a beam control means for controlling the angle of divergence of the beam of light according to changes in a measure of the distance between the illumination means and the given remote target area thereby to maintain the light intensity of the beam in cross-section at the given remote target area.

6. A blink inducer apparatus according to claim 5 in which the beam control means includes optical means arranged such that the beam of light generated by the illumination means passes through the optical means prior to exiting the blink inducer apparatus, the optical means being responsive to the control means to vary the angle of divergence of the exiting beam of light.

7. A blink inducer apparatus according to claim 6 in which the optical means includes an optical lens or mirror placed within the optical path of the beam of light and moveable along that path in such a manner as to causes the angle of divergence of the exiting light beam to increase/decrease as the optical lens/mirror is moved to and fro along the optical path of the beam within the apparatus.

8. A blink inducer apparatus according to any preceding claim in which the control means is arranged to control the angle of divergence of the beam of light according to changes in a measure of the distance between the illumination means and the given remote target area such that the value of the intensity of the beam of light in cross-section at the given target area is maintained at a predetermined value between 2 μW/cm² to 100 μW/cm².

9. A blink inducer apparatus according to any preceding claim in which the control means includes range measuring means arranged to measure the distance between the illumination means and the given remote target area, and wherein the control means is arranged to maintain the light intensity with which the beam of light illuminates the given remote target area according to changes in the measured distance between the illumination means and the given remote target area such that the remote target area is illuminated with sufficient light energy for inducing said blink response.

10. A blink inducer apparatus according to any preceding claim in which the control means is arranged to control the illumination means to direct the beam of light to fall continuously on all of a given target area during said illumination time period.

11. A blink inducer apparatus according to any preceding claim in which the illumination time period has a value from 100 ms to 500 ms.

12. A blink inducer apparatus according to any preceding claim in which said recovery time period has a value from 1 s to 10 s.

13. A blink inducer apparatus according to any preceding claim in which the control means is arranged to control the illumination means to separately illuminate and repeatedly re-illuminate each of a plurality of separate target areas which collectively define a greater target area.

14. A blink inducer apparatus according to claim 12 in which the greater target area has a value exceeding 1000 square metres, or exceeding 10000 square metres.

15. A blink inducer apparatus according to any preceding claim in which the control means is arranged to control the illumination means to redirect the beam of light from the given target area to the different target area thereby to scan the beam of light from the illuminated given target area to the subsequently illuminated different target area.

16. A blink inducer apparatus according to any preceding claim in which the illumination means includes laser means for producing said light beam as laser light.

17. A blink inducer apparatus according to any preceding claim in which the light beam conveys radiant power of less than 100 Watts or less than 50 Watts.

18. A vehicle comprising a blink inducer apparatus according to any preceding claim.

19. A method for remotely illuminating a human eye with light to induce the eye of the subject to blink in response thereto, the method including:
producing a beam of light for remotely illuminating a given target area with sufficient light energy for inducing a blink response in an irradiated human eye within the illuminated target area;
illuminating a given target area for an illumination time period sufficient to induce said blink response, and subsequently illuminating a different target area instead of the given target area, and re-illuminating the given target area after a recovery time period no greater than that sufficient for the subject to recover from the blink response.

20. A method according to claim 19 including controlling the illumination means to keep the cross-sectional area of the beam of light at the target area substantially constant.

21. A method according to claim 19 or 20 including maintaining the light intensity with which the beam of light illuminates the given remote target area according to changes in a measure of the distance between the beam source and the remote target area such that the remote target area is illuminated with sufficient light energy for inducing said blink response.

22. A method according to any of preceding claims 19 to 21 including keeping substantially constant the light intensity of the beam of light in cross-section at the given remote target area in response to changes in a measure of the distance between the beam source and the remote target area.

23. A method according to any of preceding claims 19 to 22 including controlling the angle of divergence of the beam of light according to changes in a measure of the distance between the beam source to the given remote target area thereby to maintain the light intensity of the beam in cross-section at the given remote target area.

24. A method according to any of preceding claims 19 to 23 including controlling the angle of divergence of the beam of light according to changes in a measure of the distance between the beam source and the given remote target area such that the value of the intensity of the beam of light in cross-section at the given target area is maintained at a predetermined value between 2 μW/cm² to 100 μW/cm².

25. A method according to any of preceding claims 19 to 23 including measuring the distance from the beam source to the given remote target area, and maintaining the light intensity with which the beam of light illuminates the given remote target area according to changes in the measured distance between the beam source and the remote target area such that the remote target area is illuminated with sufficient light energy for inducing said blink response.

26. A method according to any of claims 19 to 25 including directing the beam of light to fall continuously on all of a given target area during said illumination time period.

27. A method according to any of claim 19 to 26 in which the illumination time period has a value from 100 ms to 500 ms.

28. A method according to any of claims 19 to 27 in which said recovery time period has a value from 1 s to 10 s.

29. A method according to any of claims 19 to 28 including separately illuminating and repeatedly re-illuminating each of a plurality of separate target areas which collectively define a greater target area.

30. A method according to claim 29 in which the greater target area has a value exceeding 1000 square metres, or exceeding 10000 square metres.

31. A method according to any of claims 19 to 30 including redirecting the beam of light from the given target area to the different target area thereby to scan the beam of light from the illuminated given target area to the subsequently illuminated different target area.

32. A method according to any of claims 19 to 31 in which said light beam is a laser beam.

33. A method according to any of claims 19 to 32 in which the light beam conveys radiant power of less than 100 Watts or less than 50 Watts.

34. A method of remotely suppressing visual acuity in a human subject including inducing the subject to blink according to the method of any of claims 19 to 33.

35. A method of remotely suppressing a potential aggressor including inducing the potential aggressor to blink according to the method of any of claims 19 to 34.

36. Apparatus for remotely suppressing visual acuity in a human subject including the blink inducer apparatus of any of claims 1 to 18.

37. Apparatus for remotely suppressing a potential aggressor including the blink inducer apparatus of any of claims 1 to 18.

38. Apparatus substantially as described in any embodiment hereinbefore with reference to the accompanying drawings.

39. A method substantially as described in any embodiment hereinbefore with reference to the accompanying drawings.
